(19) United States
(12) Patent Application Publication
(10) Pub. No.: US 2013/0264096 A1
(43) Pub. Date: Oct. 10, 2013

(54) ELECTRODE ASSEMBLY WITH ELECTRO-CONDUCTIVE POLYMER ENCAPSULATING METALLIC INSERT, AND METHOD THEREOF

(71) Applicant: IVANHOE E. CHAPUT, Gardena, CA (US)

(72) Inventor: IVANHOE E. CHAPUT, Gardena, CA (US)

(21) Appl. No.: 13/440,438

(22) Filed: Apr. 5, 2012

(51) Int. Cl. H01B 5/00; B05D 3/02; B05D 5/12

(52) U.S. Cl. 174/126.2; 427/58

(57) ABSTRACT

An electrode assembly including a shell made of electro-conductive polymeric material in which is embedded a metallic insert such as a thin plate or wire mesh. The insert has a number of surface irregularities such as holes, indentations, or protuberances. The polymeric material shrinks after the insert is encapsulated within the shell resulting in contact pressure being exerted by the material on the irregularities and surrounding surface areas. One method of making the assembly includes coating the insert with a slurry including heat-curable polymeric material, which shrinks when cured. Another method includes encapsulating the insert within molten or liquidized polymeric material, which shrinks when cooled. Contact pressure is permanent because the high temperatures reached during thermosetting or overmolding are never reached while the assembly is being used in applications such as heating or sterilizing water, electrolysis, or oil well drilling.

### BACKGROUND OF THE INVENTION

1. Field of the Invention

The present invention relates to an electrode assembly having low bulk resistance, low contact resistance at its connection to an electrical source, high structural integrity, and excellent resistance to corrosion when immersed in an electrically conductive liquid. More particularly, the invention relates to an electrode assembly having an electro-conductive polymeric shell in which a metallic insert, strongly bonded to the polymer, is embedded.

2. Related Art

Electrodes used for heating, purifying, or electrolyzing water commonly are made of metal. Electrodes used in boilers typically use iron rods, sometimes coated with rhodium or another corrosion-resistant material. Electrodes in purifiers and electrolyzers typically are made of stainless steel or titanium. Although the choice of metal and/or coating can extend life expectancy, due to electrolytic corrosion, any metallic electrode will eventually shrink in size thereby decreasing its efficiency. Consequently, even if a unit is not discarded, there will be recurring part and labor costs in replacing the electrodes.

Electrodes made of pure carbon have been used for heating water and in vaporizers and humidifiers. Aside from their high cost, pure carbon electrodes, being soft, are vulnerable to cracking under pressure making good electrical contact difficult to achieve.

Electrical devices, which include an electro-conductive polymer physically and electrically, connected to at least one electrode suitable for attachment to a source of electrical power are well known. Among the types of electrodes that have been used are solid and stranded wires, metal foils, perforated and expanded metal sheets, porous electrodes, and conductive inks and paints.

When the conductive polymer is in the form of a sheet or a laminar element, metal foil electrodes that are directly attached to opposed surfaces of the conductive polymer, sandwiching the element, are particularly preferred. It is known that metal foils having micro rough surfaces can provide improved adhesion, resulting in improved physical and electrical stability, when used as electrodes in contact with conductive polymers. For example, U.S. Pat. No. 4,689,475 to Matthiesen discloses metal foils having microscopic surface irregularities protruding from the surface by 0.1 to 100 microns and having at least one dimension parallel to the surface, which are at most 100 microns. The primary mechanism for forming a good bond between a polymer and micro rough foil is mechanical interlocking achieved by embedding the rough surface of the foil into the polymer by heating the polymer above its melting point during the electroding process. U.S. Pat. No. 6,987,440 to Becker et al. discloses that improved electroding can be accomplished using foil having a combination of surface features making up the surface roughness of even smaller dimensions.

Overmolding a metallic contact pin that extends far into an electro-conductive polymer can increase electrical efficiency by providing a low resistance path to the far end of the electrode. However, difficulties occur when there is poor bonding between the polymer and metal. The polymeric material tends to delaminate due to a difference between the respective coefficients of thermal expansion. The poor electrical bond causes high-resistance contact arcing between the polymeric material and pin, which further increases resistance, resulting in internal burning of the material

U.S. Pat. No. 6,188,308 to Kojima et al. is directed to a positive temperature coefficient (PTC) thermostat and a manufacturing method thereof. A conductive polymer sheet is sandwiched from the top and bottom by metal foils and integrated by heat pressing to form a laminated body. The body is then sandwiched from the top and bottom by other conductive polymer sheets, and the laminated body and conductive polymer sheets are sandwiched from the top and bottom by the metal foils.

The assembly is then integrated by heat pressing. A side electrode having multiple layers is disposed at the center of the side of the laminated body so as to be electrically coupled to the inner and outer electrodes. U.S. Pat. No. 6,597,551 to Heaney is directed to a polymer current limiting device (PCL) wherein a fluoropolymer heated to about 350° C. is sandwiched between thin metal foil electrodes and the assembly is bonded at a pressure of 40,000 psi.

U.S. Pat. No. 5,955,936 to Shaw, Jr. et al. discloses a polymer PTC electrical circuit protection device wherein an electro-conductive polymer is sandwiched between a pair of electrodes, each having a three-dimensional, initially open cellular structure such as nickel foam. Under high temperature and pressure, the cells fill with polymeric material resulting in a laminate having lower resistance and improved mechanical adhesion.

U.S. Pat. No. 6,051,778 to Ichinose et al. discloses an electrode structure formed by superposing a bar-shaped or linear metal member on an electro-conductive polymeric layer. In one embodiment the layer has a thickness larger than the diameter or thickness of the metal member so as to fully embed the metal member and connect the member to a busbar. The structure exhibits low resistance, high adhesion and high reliability.

### SUMMARY OF THE INVENTION

In one aspect an electrode assembly according to the invention provides a shell made of electro-conductive polymeric material, which has at least one outer surface. A metallic insert having at least one outer surface with a plurality of irregularities at least one surface is embedded within the shell. The polymeric material encapsulating the insert undergoes shrinkage such that The material on the irregularities as well as on contiguous surface areas exerts contact pressure.

In a second aspect an electrode assembly includes a rectangular-shaped shell and a thin metallic plate embedded within the shell. The plate has a plurality of holes, each of which has a bore surface.

The plate terminates at one end in a metallic wire connector tab, which protrudes through a shell edge. The polymeric material encapsulating the plate undergoes shrinkage such that contact pressure is exerted by the material on the bore surfaces as well as on plate surface areas contiguous to the holes.

In a third aspect an electrode assembly includes a rectangular-shaped shell and a thin metallic wire mesh embedded within the shell. The mesh has a plurality of holes formed by crisscrossed wire segments, and terminates in an end protruding through a shell edge. The polymeric material encapsulating the mesh undergoes shrinkage such that the material on the wire segments, which determine the holes, exerts contact pressure.

In a fourth aspect the invention provides a method for making an electrode assembly, including the steps of: (a) forming a slurry consisting of a heat-curable electro-conductive polymeric material and a solvent; (b) coating the slurry over a metallic insert having at least one outer surface with a plurality of irregularities at least one surface; (b) evaporating the solvent, and (c) heat curing the polymer material, thereby shrinking the material so as to exert contact pressure on the irregularities and on contiguous surface areas.

In a fifth aspect the invention provides a method for making an electrode assembly, including the steps of: (a) heating to its melting point an electro-conductive polymeric material which shrinks when cooled; (b) encapsulating within the molten material a metallic insert having at least one outer surface with a plurality of irregularities at least one surface; and (c) cooling the material, thereby shrinking the material so as to exert contact pressure on the irregularities and contiguous surface areas.

### BRIEF DESCRIPTION OF THE DRAWINGS

FIG. 1 is a perspective sectional view of an electrode assembly according to a first embodiment of the invention, including an electro-conductive polymeric shell and a metallic plate embedded within the shell.

FIG. 2 shows the FIG. 1 plate having a plurality of holes therethrough, and attached at one end to a wire connector tab.

FIG. 3 is a perspective view of the FIG. 1 electrode assembly with the shell encapsulating the plate and the FIG. 2 tab extending through a shell edge.

FIGS. 4 and 5 are cross-sectional views taken, respectively, along lines 4-4 and 5-5 of FIG. 3.

FIG. 6 is a perspective sectional view of an electrode assembly according to a second embodiment of the invention, including an electro-conductive polymeric shell and a wire mesh screen embedded within the shell, with an end portion of the screen protruding through the shell.

FIG. 7 shows the FIG. 6 screen having a plurality of holes therethrough.

FIG. 8 is a perspective view of the FIG. 6 electrode assembly with the shell encapsulating the plate, and the screen end portion protruding through a shell edge to serve as a wire connector.

### DETAILED DESCRIPTION OF THE PREFERRED EMBODIMENTS

While the present invention is open to various modifications and alternative constructions, the two preferred embodiments shown in the drawings are described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

As used herein, the term “metallic insert” means a metal structure, which is totally embedded within an electro-conductive polymeric shell. The insert may be planar-shaped such as a plate or mesh, or be symmetric about a longitudinal axis such as a cylinder, or have any other shape compatible with shell dimensions. As used herein, the term “plurality of irregularities” means a number of discontinuities at least one outer surface of the insert, each of which may be a hole through the insert, an indentation terminating within the insert body, or a protuberance extending from the outer surface. As illustrated in FIGS. 2 and 7, this number may be in a range from tens to hundreds. As used herein, the term “shell” means a body made of electro-conductive polymeric material, which can be of any shape and dimensions compatible with the intended use of the electrode assembly.

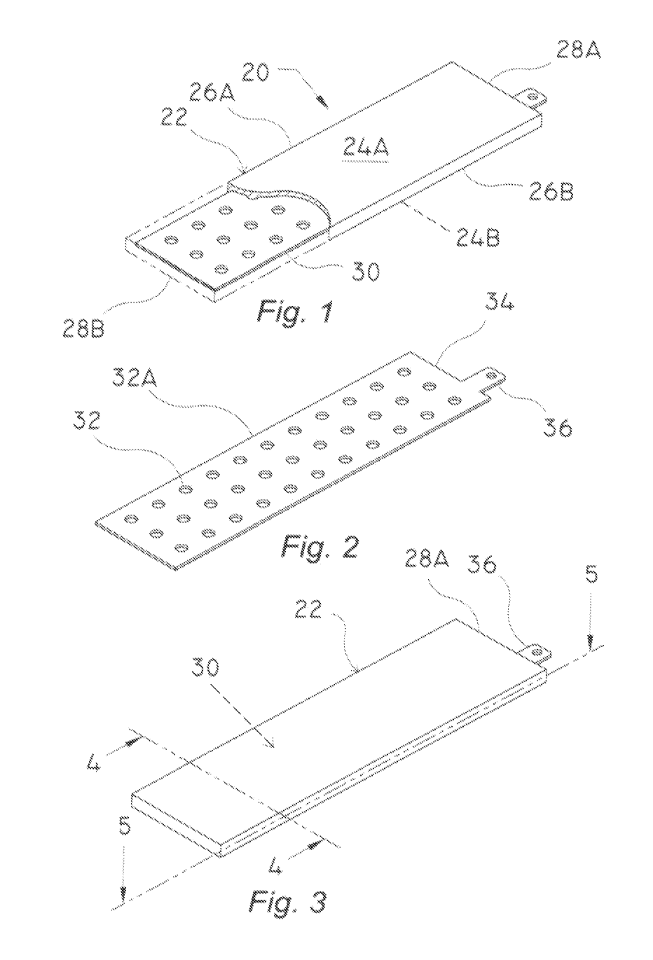

Referring to FIG. 1, a first embodiment of an electrode assembly 20 according to the invention includes an electro-conductive polymeric shell 22 having opposed, generally planar outer surfaces 24A, 24B, opposed, generally planar edges 26A, 26B, and opposed, generally planar edges 28A, 28B generally orthogonal to edges 26A, 26B and surfaces 24A, 248. An insert in the shape of a thin, generally planar metallic plate 30 is embedded within the shell 22. Referring to FIG. 2, the plate 30 has a plurality of holes 32 therethrough, each having a bore surface 32B, and terminates at an end 34 attached to a metallic wire connector tab 36. Referring to FIG. 3, shell 22 encapsulates plate 30, and tab 36 protrudes through shell edge 28A. Tab 36 is an electrical contact lug or quick-connect type connector, which is potted to seal it from ambient liquid.

Electrode assembly 20 may be formed by dipping the plate 30 into an electro-conductive slurry so as to coat the plate with slurry, which is then allowed to dry. A slurry composed of a vinyl chloride polymer (PVC) and a solvent is preferred when dipping or manual application is used. When a phenolic such as RESOL™ or NOVOLAC™ is used, heat curing in a range of 60 to 80° C., the molding of which is well known causes shrinkage of the thermoset material.

Alternatively, electro-conductive polymer material may be overmolded onto plate 30 using injection molding, transfer molding, or compression molding. For injection molding the plate is placed within a mold and polymer pellets added. As the pellets are heated to the melt temperature they expand and melt, while the insert expands far less. The molten polymer, under pressure, encapsulates the insert. The assembly is then cooled prior to being removed from the mold. Depending on the polymeric material used, its shrink rate is in a range of about 0.2 percent to about 1.9 percent. Once the molten material has cooled, a mechanical pressure equal to the tensile strength of the polymer at its respective shrink factor provides an excellent electrical contact pressure that will endure for the life of the assembly.

When the slurry technique is used, liquid polymeric material covers all plate surfaces and fills the holes 32. When the material is heated to curing temperature, the material shrinks thereby exerting contact pressure against the bore surfaces 328 and the plate surfaces.

When overmolding is used, the polymeric material is heated to a molten state and undergoes thermal expansion before being introduced to encapsulate the plate. As the assembly cools, polymeric material 38 filling the holes 32 shrinks thereby exerting contact pressure against bore surfaces 328 and plate surfaces.

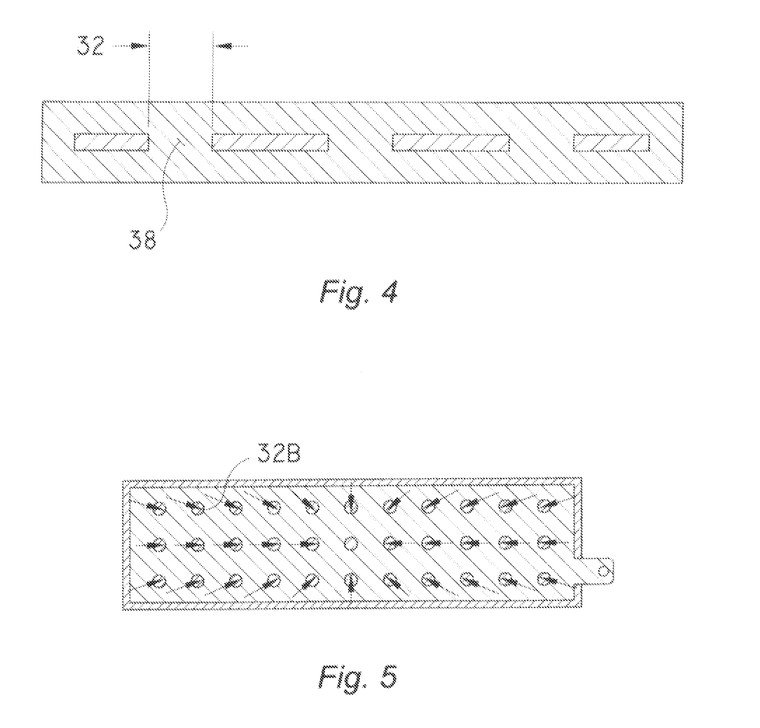

FIG. 4 shows exemplary holes 32 filled with the material 38. FIG. 5 shows the direction, after cooling, of the stress vector against each bore surface 32B for the 3×11 array of holes shown in FIG. 2.

Shrinkage provides contact pressure between the bore surfaces and material which is not relieved thereafter because the high temperatures reached during thermosetting or molding are never reached while the assembly is being used in applications such as heating or sterilizing water, electrolysis, and oil well drilling. Such applications would never exceed the polymer's glass transition temperature, so that the contact pressure would last indefinitely.

In normal use the difference in the coefficient of thermal expansion of the metal, relative to that of the polymer at the molding temperature is approximately 13-fold. Approximately the same shrink factor applies for a PVC slurry.

The permanent mechanical stress of the polymer against the metallic surfaces provides excellent and multiple electrical surfaces dispersed throughout the bulk of the assembly, enabling optimum electric conductivity within the assembly.

Polymeric material used in the invention can be of any polymeric compound such as polypropylene, polyethylene, polyphenylene sulfide, ethylene vinyl acetate, polycarbonate, nylon, phenolic, or any other polymer having rigid or semi-flexible properties. The material is compounded with conductive particles such as carbon black, exfoliated graphite, lampblack, carbon fibers, nanotubes or any other conductive particles including metallic particles, to form an electro-conductive polymer.

The thickness of shell 22 must not be so large as to cause overheating of the polymer. Acceptable thicknesses are in a range from ¼-inch to a thin layer just coating the plate 30 to prevent electrolysis of the metal. Preferably, the thickness is ⅛-inch; most preferably, it is 1/32 inch. Such a thin layer decreases the power density throughout the bulk of the polymeric material, thereby reducing internal heating.

The number density and size of the holes 32 are important. The spacing between nearest neighbor holes must be sufficiently small and the bore surface of each hole sufficiently large to prevent delamination, particularly at high current. The metal face spacing between holes can be 3/16 of an inch, preferably ⅛ inch and most preferably 1/32 of an inch. The metal plates can be any metal such as aluminum or brass, preferably mild steel and most preferably stainless steel such as a 316L. Electrode size is dependent on its use. No particular size electrode fits all applications, however there are limitations in fabrication. For electrolyzers, water heaters, and other small devices, an opposed face area between electrode pairs can be 5 square inches for small electrodes to as much as 120 square inches for tubular electrodes. A preferred opposed face area for electrolyzers can be approximately 36 square inches.

For down hole electrodes used in the oil-drilling field, tubular electrodes can have 800 to 1,000 square inches. For this application, only a single electrode is used to descend into the well as the pipe is charged with the opposite polarity.

An electrode assembly according to the invention provides several advantages. No bonding or cross-linking agents are used during fabrication.

No chemical bonding agents, coupling agents, conductive electrical coupling epoxies or chemicals are required to ensure excellent electrical contact between the polymer and metallic surfaces.

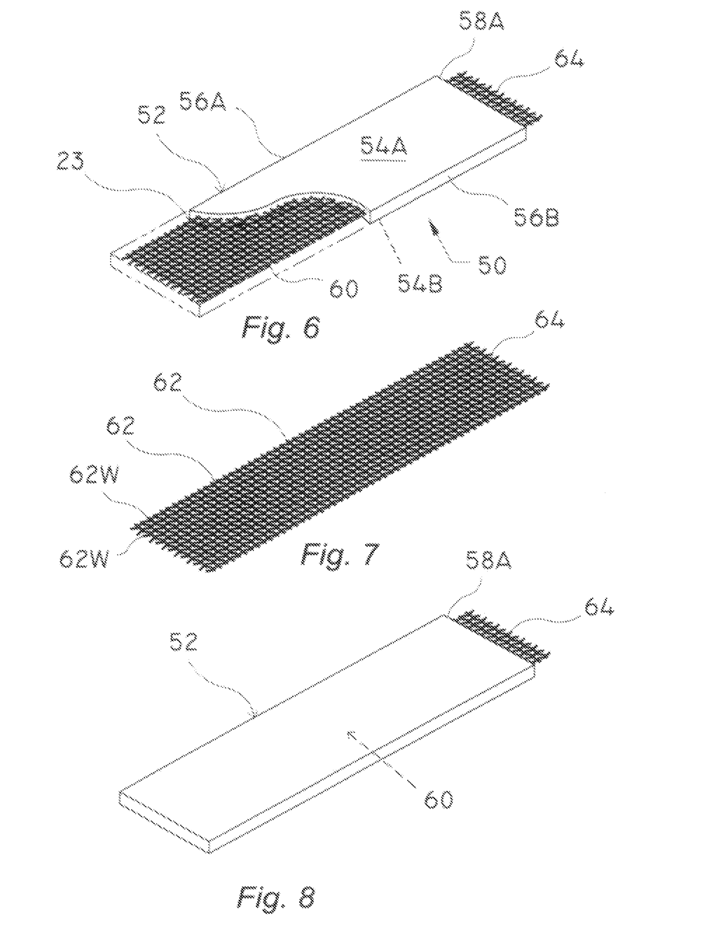

Electro-conductive polymeric material is expensive and many applications require several electrodes. A metallic insert reduces the amount of material by as much as 30 percent while also providing structural strength to the material, which may be fragile or brittle. Also, as required by Underwriters' Laboratory, a metal-to-metal electrical connection can be made directly to tab 36, thus eliminating the need to make a high resistance connection directly to shell 22. Referring to FIG. 6, a second embodiment of an electrode assembly 50 according to the invention includes an electro-conductive polymeric shell 52 having opposed, generally planar outer surfaces 54A, 54B, opposed, generally planar edges 56A, 56B, and opposed, generally planar edges 58A, 58B generally orthogonal to edges 56A, 56B and surfaces 54A, 54B. An insert in the shape of a thin, generally planar metallic wire mesh 60 is embedded within the shell 52. Referring to FIG. 7, the mesh 60 has a plurality of holes 62 formed by crisscrossed wire segments 62W, and terminates in an end portion 64. Referring to FIGS. 6 and 8, shell 52 encapsulates mesh 60, and end portion 64 protrudes through shell edge 58A to serve as an electrical connector.

The electrode assembly 50 may be formed by dipping the mesh 60 into an electro-conductive slurry or painting the slurry onto the mesh, such as for the first embodiment. The coated mesh is then allowed to dry before the assembly is heated to curing temperature. Alternatively, as for the first embodiment, electro-conductive polymer material may be overmolded onto mesh 60 using injection molding, transfer molding, or compression molding.

As in the first embodiment, the shrink rate of the polymeric material is in a range of about 0.2 percent to about 1.9 percent. As polymer material filling the holes 62 and coating the wire segments 62W shrinks, the material exerts contact pressure against the segments.

What is claimed is:

1. An electrode assembly comprising:
A shell made of electro-conductive polymeric material having a pre-selected shrink rate, the shell having at least one outer surface;
a metallic insert having at least one outer surface with a plurality of irregularities at least one said surface, the insert embedded within the shell; and
the polymeric material encapsulating the insert undergoing shrinkage such that contact pressure is exerted by the material on the irregularities and causing a tight electrical connection on surface areas contiguous thereto.

2. The assembly of claim 1 wherein the insert is a plate having a plurality of holes therethrough, each hole having a bore surface, polymeric material filling the holes and exerting contact pressure on the bore surfaces and on plate surface areas contiguous to the holes.

3. The assembly of claim 1 wherein the insert is a wire mesh having a plurality of holes determined by crisscrossed wire segments, polymeric material filling the holes and exerting contact pressure on the segments determining each hole.

4. The assembly of claim 1, wherein the shrink rate is in a range from about 0.2 percent to about 1.9 percent.

5. An electrode assembly comprising:
A shell made of electro-conductive polymeric material having a pre-selected shrink rate, the shell having opposed outer surfaces, a first pair of opposed edges, and a second pair of opposed edges generally orthogonal to the surfaces and to the first pair of edges;
a thin, generally planar metallic plate embedded within the shell, the plate having a plurality of holes therethrough, each having a bore surface, the plate terminating at an end attached to a metallic wire connector tab, the tab protruding through a shell edge; and
the polymeric material encapsulating the plate undergoing shrinkage such that contact pressure is exerted by the material on the hole bore surfaces and on plate surface areas contiguous to the holes.

6. The assembly of claim 5, wherein the shrink rate is in a range from about 0.2 percent to about 1.9 percent.

7. The assembly of claim 6, wherein the polymeric material becomes molten when heated to its melting temperature and shrinks upon cooling.

8. The assembly of claim 7, wherein the polymeric material comprises a polymer selected from the group consisting of polypropylene, polyethylene, polyphenylene sulfide, ethylene vinyl acetate, polycarbonate, epoxy, nylon, and phenolic.

9. The assembly of claim 6, wherein the polymeric material is a phenolic, or other thermoset material, such as a powder coat epoxy which shrinks when heat cured.

10. An electrode assembly comprising:
A shell made of electro-conductive polymeric material having a pre-selected shrink rate, the shell having opposed outer surfaces, a first pair of opposed edges, and a second pair of opposed edges generally orthogonal to the surfaces and to the first pair of edges;
a thin, generally planar metallic wire mesh embedded within the shell, the mesh having a plurality of holes formed by crisscrossed wire segments and terminating in an end protruding through a shell edge;
and the polymeric material encapsulating the mesh undergoing shrinkage such that contact pressure is exerted by the material on the wire segments determining the holes.

11. The assembly of claim 10, wherein the shrink rate is in a range from about 0.2 percent to about 1.9 percent.

12. The assembly of claim 11, wherein the polymeric material becomes molten when heated to its melting temperature and shrinks upon cooling.

13. The assembly of claim 12, wherein the polymeric material comprises a polymer selected from the group consisting of polypropylene, polyethylene, polyphenylene sulfide, ethylene vinyl acetate, polycarbonate, nylon, and phenolic.

14. The assembly of claim 11, wherein the polymeric material is a phenolic, or other thermoset material such as a powder coat epoxy which shrinks when heat cured.

15. A method for making an electrode assembly, comprising the steps of
(a) forming a slurry consisting of a heat-curable electro-conductive polymeric material having a pre-selected shrink rate when cured, and a solvent;
(b) coating the slurry over a generally planar metallic insert having at least one outer surface with a plurality of irregularities at least one said surface;
(c) evaporating the solvent; and
(d) heat curing the polymeric material, thereby shrinking the material so as to exert contact pressure on the irregularities and on surface areas contiguous thereto.

16. A method for making an electrode assembly, comprising the steps of:
(a) heating to its melting point an electro-conductive polymeric material having a pre-selected shrink rate when cooled;
(b) encapsulating within the molten material a generally planar metallic insert having at least one outer surface with a plurality of irregularities at least one said surface; and
(c) cooling the material, thereby shrinking the material so as to exert contact pressure on the irregularities and surface areas contiguous thereto.
